(19) United States
(12) Patent Application Publication
(10) Pub. No.: US 2026/0210460 A1
(43) Pub. Date: Jul. 23, 2026

(54) COUPLING WITH SETPOINT TIGHTENING TORQUE

(71) Applicant: SENIOR AEROSPACE ERMETO, Fosse (FR)

(72) Inventors: Mathieu JURION, Fosse (FR); Didier ROCHEREAU, Fosse (FR); Benjamin RAPP, Fosse (FR); Alexandre DIOT, Fosse (FR); Clément SIESKY, Fosse (FR); Pierre LAGORS, Fosse (FR); Patrick GUENAIRE, Fosse (FR)

(21) Appl. No.: 19/138,837

(22) PCT Filed: Dec. 13, 2023
(86) PCT No.: PCT/FR2023/051996

§ 371 Date: Jun. 13, 2025

(30) Foreign Application Priority Data
Dec. 13, 2022 (FR) FR2213268
Dec. 12, 2023 (FR) FR2314006

(51) Int. Cl. F16L 19/02; G01L 5/24

(52) U.S. Cl. CPC F16L 19/0225; G01L 5/24; F16L 2201/10; F16L 2201/60

(57) ABSTRACT

Coupling with a setpoint torque for connecting two pipes (C1, C2), the coupling comprising:—a first end piece (1) attached to a first pipe (C1);—a second end piece (2) attached to a second pipe (C2);—a clamping nut (3) that is borne by the second end piece (2) and clamps the latter against the first end piece (1). In the coupling (100)—the first end piece (1) has a nut crown (11) for holding the end piece (1) for the screwing thereof and an angular reference (111);—the nut (3) has an index (311);—the run-out and the pitch of the thread of the threaded segment (12) of the first end piece (1) and of the thread of the nut (3) are designed so that the positioning of the index (311) of the nut (3) relative to the reference (111) of the first end piece (1) corresponds to the exact tightening of the coupling (100).

### FIELD OF THE INVENTION

The present invention relates to a coupling with a setpoint tightening torque for connecting two pipes comprising: a first end piece attached to a first pipe, a second end piece attached to a second pipe, a clamping nut that is borne by the second end piece and clamps the latter against the first end piece, the first end piece having on its free side a threaded segment terminating in an end forming a sealing surface, the second end piece having an end provided with a sealing collar equipped with a lip designed to be clamped against the sealing surface of the first end piece, the nut fitted feely rotating on the second end piece overlapping its sealing collar and screwing onto the threaded segment of the first end piece to push against its collar and clamp its sealing lip against the sealing surface.

### STATE OF THE ART

It is known to tighten couplings connecting two pipes with a setpoint tightening torque. For this purpose, a torque wrench set to the setpoint torque is used so that there is no need to take into account the end movement of the torque wrench.

However, fast, repetitive operations such as those encountered in industry are time-consuming to carry out with a torque wrench. In addition, the adjustment of the torque wrench may be inaccurate. The accuracy of the tightening also depends on the speed at which the tightening is carried out.

### PURPOSE OF THE INVENTION

The purpose of the present invention is to develop a coupling that allows precise, exact tightening and that also makes it possible to know the exact tightening position and check the tightening at any time.

### DISCLOSURE AND ADVANTAGES OF THE INVENTION

For this purpose, the invention relates to a coupling with a setpoint tightening torque for connecting two pipes comprising: a first end piece attached to a first pipe, a second end piece attached to a second pipe, a clamping nut that is borne by the second end piece and clamps the latter against the first end piece, the first end piece having on its free side a threaded segment terminating in an end forming a sealing surface, the second end piece having an end provided with a sealing collar equipped with a lip designed to be clamped against the sealing surface of the first end piece, the nut fitted feely rotating on the second end piece overlapping its sealing collar and screwing onto the threaded segment of the first end piece to push against its collar and clamp its sealing lip against the sealing surface.

This exact tightening thus represents the deformation imposed on the sealing lip to ensure the desired sealing.

The coupling according to the invention has the advantage of being extremely simple to use since the coupling is prepared in the factory so that its tightening position displayed by the angular reference of the first end piece and the index of the nut performing the tightening makes it possible to know the exact tightening position at which the tightening must be stopped.

This operation is quick and safe because it does not require any special wrench to carry out the tightening. All that is required is to tighten once the lip and the bearing surface are in contact until the angular reference of the first end piece and the index of the nut are in alignment; a trace of the correct tightening remains, displayed by the coupling.

The axial index can also be replaced by a radial index to define a tightening range.

In another advantageous feature, the nut crown of the first end piece is a faceted hexagonal crown and the head of the nut is a hexagonal head, the reference of the nut crown of the first end piece corresponds to a facet of the crown and the index of the nut head corresponds to a facet of this nut head.

The angular reference of the nut crown and the index of the nut head are visible elements definitively associated one with the nut crown of the first end piece and the other with the nut head of the nut, so that the relationship between the first end piece with its nut crown and the clamping nut is defined in the factory definitively by this association.

In a further advantageous feature, the hexagonal nut crown has a reference consisting of the numbers 1 to 6 and the nut head has its facets equipped with an index consisting of the numbers 1 to 6 associated respectively with each facet, the exact tightening position being that in which all the numbers on the nut head are aligned two-by-two with those on the nut crown, while a position in which the numbers of the index are below the reference corresponds to insufficient tightening and one in which the numbers of the index exceed those of the reference corresponds to excessive tightening.

The form given to the angular reference of the nut crown and to the index of the nut head by the series of numbers 1 to 6 makes it easy to recognize the concordance between the tightening position of the nut and that of the nut crown, whatever the orientation of the nut, since the numbers on both the nut crown and the nut head are distributed over the whole periphery of each of the two parts of the coupling.

This is particularly advantageous for visually checking adjustments and makes it possible, whatever the position and orientation of the coupling in an installation, to find a viewing angle to check the alignment of the angular reference and the index confirming the exact adjustment of the tightening.

Another advantageous feature is that the reference of the nut crown consists of an axial line associated with the number reference, and the index of the nut head is an axial line carried on the cylindrical surface extending the nut by its threaded part screwed onto the threaded segment of the first end piece.

This angular reference and the index constituted by a respective line allow precise positioning of the nut in relation to the nut crown. This positioning is more precise than alignment of the positioning of the facets of the nut crown and the facets of the nut head.

In another advantageous feature, the angular reference consists of a visible peripheral surface on the first end piece between the nut crown and the thread and a blank area chosen according to the rotation position of the nut, the index being at least one window in a sleeve of the nut arriving at the end of the screwing of the nut to reveal the blank area.

The position of the blank area is predefined so that this area appears alone in the window(s) when the nut is in the setpoint tightening position, with the threading and tapping being made in accordance with this objective.

In a further advantageous feature, the window is duplicated and the blank area is duplicated in a matching way.

This duplication creates a preparatory position for the setpoint tightening position drawing attention to the approach of the setpoint tightening position when tightening the nut. This also increases the accuracy of the setpoint tightening position by reducing the width of the windows and the matching blank areas. Overall, the implementation of these means of detecting the setpoint tightening position is very simple and the tightening is quick. In addition, the setpoint tightening is easy to detect if the visible surface is covered with a color that is sensitive to light radiation, for example UV radiation.

The visible surface is also obtained by the surface condition of this part of the end piece which is visibly distinguishable from its surroundings on the end piece.

In summary, the coupling according to the invention can be easily tightened in a very precise way and the adjustment is unvarying, independently of the installer's intervention, because this adjustment is associated with the alignment of a mark on the first end piece and a mark on the nut head. The exact tightening result, i.e. with a precise deformation of the sealing lip from its contact position against the sealing surface, is independent of variations in adjustment by the installer and remains visible after the coupling has been tightened.

### BRIEF DESCRIPTION OF THE DRAWINGS

The present invention will be described below in greater detail using an embodiment of a coupling shown in the attached drawings in which:

FIG. 1 is a side view of a coupling according to the invention connecting two pipes,

FIG. 2 is an axial section view of the coupling in FIG. 1,

FIG. 3 is a diagram showing axial half-sections of the components of the coupling according to the invention,

FIG. 4 is a perspective view of a coupling according to the invention, in the assembled state,

FIG. 5 is a pre-assembly view of another embodiment of the coupling,

FIG. 5A is an axial section view of FIG. 5,

FIG. 6 shows, in its parts A, B, and C, the variation of the display during the tightening of the nut until the setpoint tightening is reached.

### DESCRIPTION OF AN EMBODIMENT OF THE INVENTION

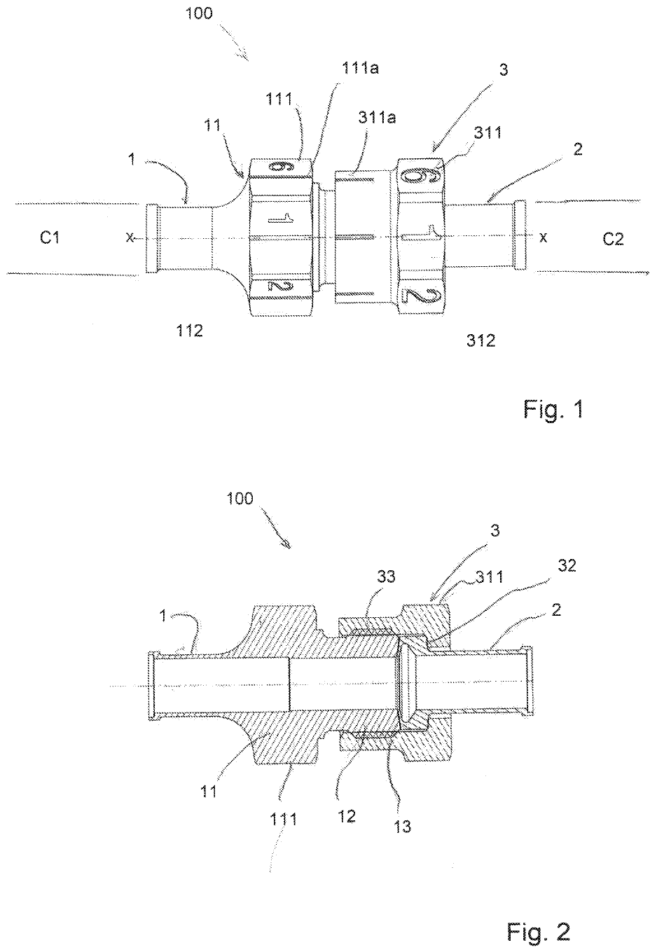

In FIG. 1, representing a first embodiment, the invention relates to a coupling 100 for connecting two pipes C1, C2, this coupling having to be tightened in a precise manner, i.e. with a precise deformation of the sealing lip from its contact position against the sealing surface.

The coupling 100 comprises a first end piece 1 attached to the first pipe C1 and a second end piece 2 attached to the second pipe C2 as well as a nut 3 fitted on the second end piece 2 to be screwed onto the first end piece 1 with an exact tightening of the sealing lip against its bearing surface. This tightening is called the setpoint tightening.

FIG. 2 is an axial section view of the coupling in FIG. 1 showing the coupling 100 tightened exactly.

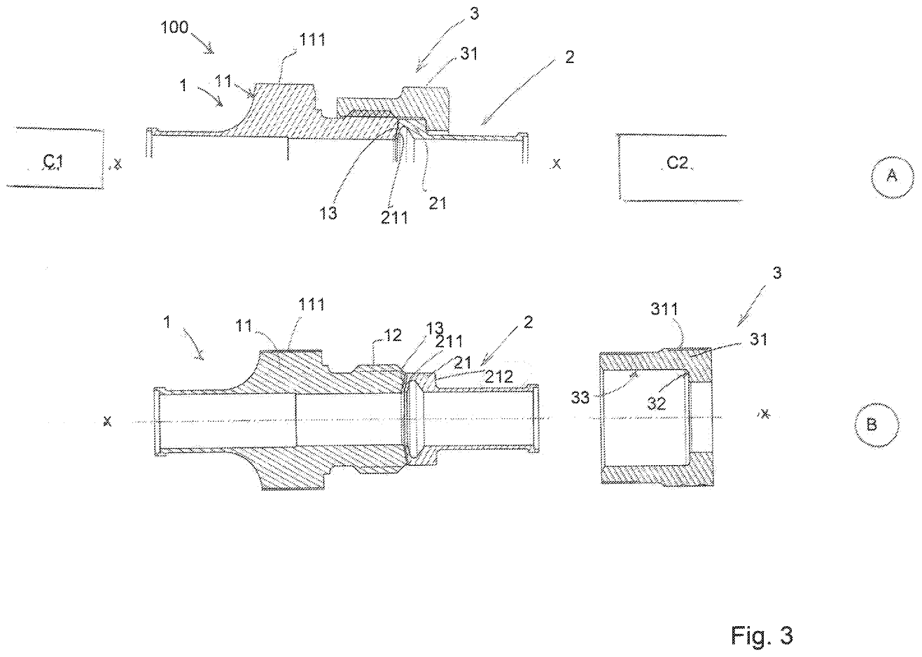

In FIGS. 2 and 3, the coupling 100 intended to be tightened exactly to the setpoint tightening according to the invention consists of the first end piece 1 generally in the shape of a sleeve, one end of which is connected to the pipe C1 while the other end is designed to be joined to the matching end of the second coupling 2 by the clamping nut 3.

In the axial half-section view in FIG. 3, the first end piece 1 has a nut crown 11 whose periphery forms a tool gripping surface, for example a hexagonal surface with facets 112 or flats. The first end piece 1 also has an angular reference 111, carried for example on the tool gripping surface of the crown 11 or on another location on the peripheral surface of the first end piece 1.

Beyond the nut crown 11, near its second end, the first end piece 1 has a threaded segment 12 that ends in a sealing surface 13 that is flat in a plane perpendicular to the axis XX of the coupling 100 or conical around the axis XX.

The second end piece 2, designed to be applied against the first end piece 1 to seal the coupling, consists of a sleeve, one end of which is designed to be connected to the pipe C2 while the other end terminates in a sealing collar 21 that is raised with respect to the remaining cylindrical part of the end piece 2.

The collar 21 has a sealing lip 211; the other side of the collar 21 forms a flat or conical support crown 212. The sealing lip 211 must be pressed against the sealing surface 13 with a precise deformation.

The third component of the coupling, the clamping nut 3, is fitted on the second end piece 2. This fitting of the clamping nut 3 on the second end piece 2 is carried out before the second end piece 2 is connected to the pipe C2.

The clamping nut 3 fitted on the second end piece 2 is a cylindrical shaped element with a circular cross-section having a nut crown 31 externally forming a tool gripping surface, for example a succession of facets forming a hexagonal nut head, and, at one end, an internal thread 33 corresponding to the threaded segment 12 of the first end piece 1.

The internal thread 33 is made in the part of the nut 3 which is at the diameter of the threaded segment 12 of the first end piece 1 while the other end of the nut 3 is a circular cylindrical surface of smaller diameter than that of internal thread 33 so as to form a bearing surface 32 which comes up against the bearing surface 212 of the sealing collar 21 of the end piece 2 to press the lip 211 against the sealing surface 13 of the first end piece 1 with a precise deformation corresponding to the required sealing that it must provide.

The nut 3 has an index 311, created for example on the surface of the nut crown 31, such as the marking of a facet 312 or of all the facets of the nut crown 31.

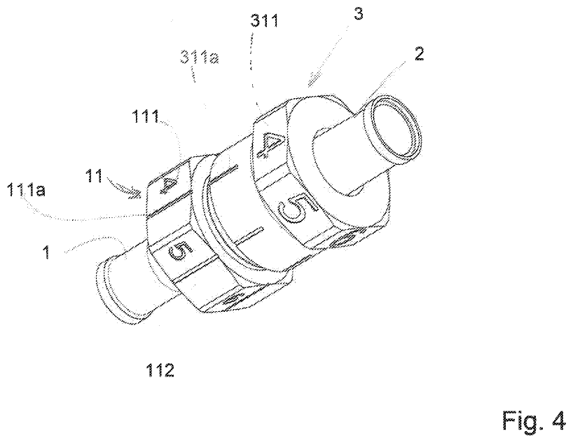

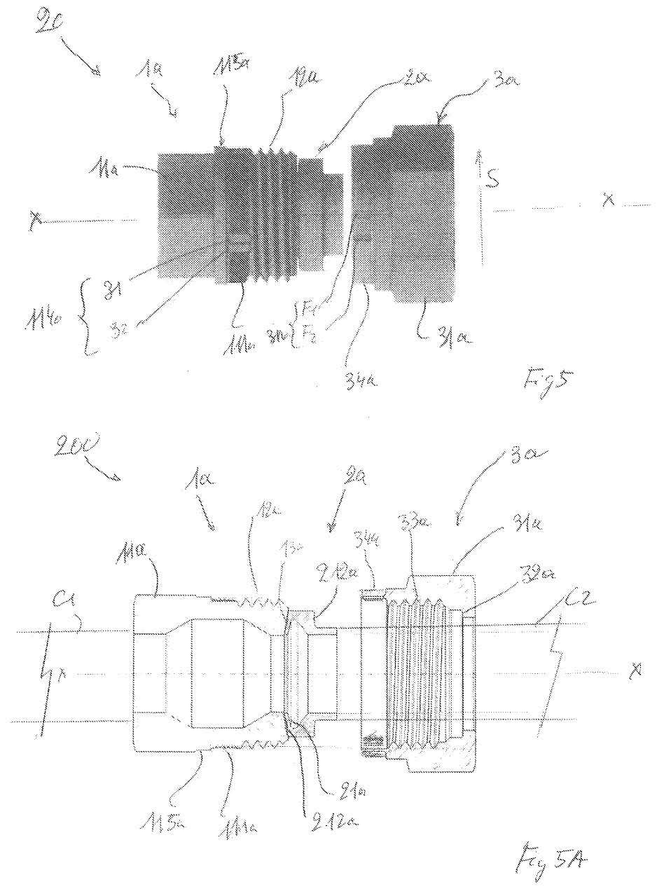

In FIGS. 1 and 4, the hexagonal nut crown 11 has facets 112 with one or more angular references 111 consisting of the numbers 1 to 6. The nut head 31 has its facets 312 equipped with an index 311 consisting of the numbers 1 to 6 associated respectively with each facet 312. The exact tightening position corresponds to the alignment of the numbers on the nut head 31 with those on the nut crown 11. The indexes and references also make it possible to detect excessive or insufficient tightening because a position in which the numbers of the index 311 are below those of the angular reference 111 corresponds to insufficient tightening and one in which the numbers of the index 311 exceed those of the angular reference 111 corresponds to tightening with an excessive torque.

For greater tightening precision, the angular reference 111 of the nut crown 11 consists of an axial line 111a associated with the numbers and the index 311 of the nut 31 is complemented by an axial line 311a carried on the cylindrical surface extending the nut head 31 by its threaded extension, screwed onto the threaded segment 12 of the first end piece 1.

The alignment lines 11a, 311a are advantageously provided on all the numbers or facets 112, 312 representing the reference 11 and the index 311 which represent a peripheral structure that can be read from all angles.

According to the invention, the threaded segment 12 of the end piece 1 has a thread to which the internal thread 33 of the clamping nut 3 corresponds. The tightening phase begins with the sealing lip 211 coming into contact with the bearing surface 13. This contact is perceived when screwing. This angular contact position is separated from the exact tightening position by only a fraction of a turn. The positioning of the index 311 in relation to the reference 111 corresponds to a movement starting from this contact of the angular rotation segment, in which the nut 3 must be turned to align the index 311 with the reference 111.

The clamping nut 3 has an internal thread 33 such that the screwing of nut 3 to the exact tightening of the lip 211, i.e. its optimal elastic deformation, results in alignment between the index 311 of the nut 3 and the angular reference 111 of the end piece 1.

This also requires the precise positioning of the start of the internal thread 33 of the clamping nut 3 since, before the coupling 100 is installed on the site, the first end piece 1 is separated from the sub-assembly consisting of the second end piece 2 and the clamping nut 3 fitted on the second piece 2 before this second end piece 2 is attached to the pipe C2 and, at the same time, the first end piece 1 is attached to the first pipe C1.

The tightening begins when the lip 211 comes into contact with the bearing surface 13 through the rotation of the nut 3 with respect to the first end piece 1 and thus the engagement of the internal thread 33 of the nut 3 on the threaded segment 12 of the first end piece 1. Screwing continues until, after the first contact between the lip 211 and the bearing surface 13, the index 311 on the clamping nut 3 is aligned with the reference 111 on the nut crown 11.

The alignment of the index 311 with the reference 111 is therefore the “signature” of the coupling 100 tightened to the exact tightening of the sealing lip 211 against the bearing surface 13.

This signature remains on the coupling 100 and can be checked at any time.

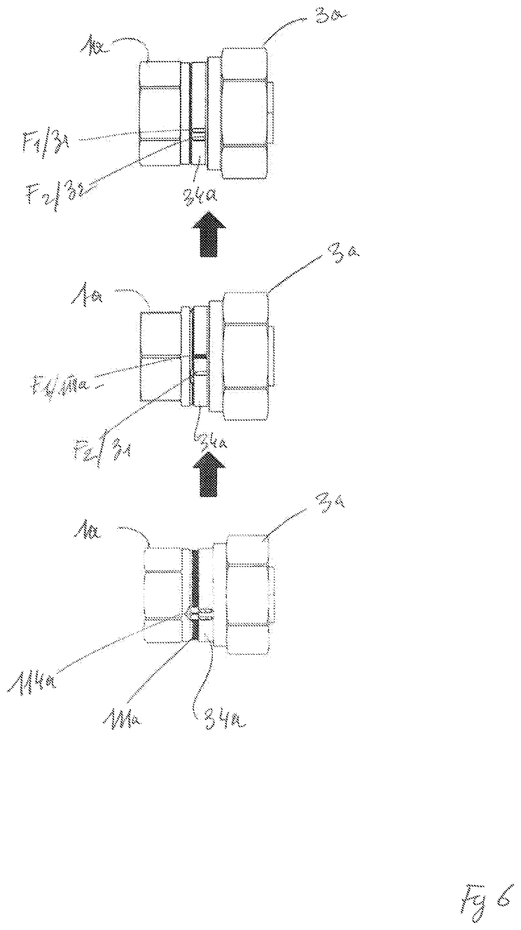

FIGS. 5 and 5A show a second embodiment which is a coupling 200 designed to connect two pipes (not shown). This coupling must be tightened precisely as already indicated. By convention, elements identical or analogous to those of the first index bear the same numerical references, with the addition of the suffix (a).

The coupling 200 comprises a first end piece 1a attached to a first pipe C1 and a second end piece 2a attached to a second pipe C2 as well as a nut 3a fitted on the second end piece 2a to be screwed onto the first end piece 1a with an exact tightening called the setpoint tightening.

The first end piece 1a is a sleeve, one end of which is connected to the pipe C1 while the other end is designed to be connected to the matching end of the second coupling 2a by the clamping nut 3a.

The first end piece 1a has a nut crown 11a whose periphery forms a tool gripping surface, for example a hexagonal surface. The first end piece 1a has an angular reference consisting of a circular crown-shaped peripheral surface 111a after the nut crown 11a and a blank area 114a. This circular crown bordered by a collar 115a is followed by a threaded segment 12a ending in the sealing surface 13a.

The second end piece 2a comprises, at its end facing the first end piece, a sealing collar 21a forming a support crown 212a which must be pressed against the sealing surface 13a of the first end piece 1a.

The clamping nut 3a is fitted on the second end piece 2a before it is connected to its pipe. The nut is a cylindrical shaped element with a circular cross section having a nut crown 31a externally forming a tool gripping surface, for example hexagonal, and, at the end, an internal thread 33a corresponding to the threaded segment 12a of the first end piece 1a.

The internal thread 33a is made on the part of the nut 3a which is at the diameter of the threaded segment 12a of the first end piece 1a while the end of the nut 3a is a circular cylindrical surface of smaller diameter than that of internal thread so as to form a bearing surface 32a which comes up against the bearing surface 212a of the sealing collar 21a of the end piece 2a to press it against the sealing surface 13a of the first end piece 1a in a precise way.

The nut 3a has an index 311a created on its cylindrical extension which extends beyond the threaded segment 12a at the end of the screwing.

The peripheral surface 111a on the first end piece 1a extends over the whole crown or only over a circular part of the crown bounded axially by the collar 115a.

The peripheral surface 111a is surface that is made visible either by its nature which distinguishes it from its surroundings on the end piece 1a, for example surface irregularities such as knurling, or by a particular physical characteristic which makes it visible in particular under certain lighting, for example UV light, or with the addition of this visual characteristic.

Generally, however, this surface must be visible to the naked eye even if it is not illuminated by a particular light. This visible peripheral surface 111a is interrupted locally by a blank area 114a associated with the setpoint tightening position of the coupling.

The nut 3a is extended beyond its internal thread 33a by a sleeve 34a comprising an index 311a associated with the setpoint tightening position and cooperating with the angular reference of the first end piece 1a consisting of the peripheral surface 111a and the blank area 114a to detect, during the rotation of the nut 3a relative to the end piece 1a, the relative rotation position corresponding to the setpoint tightening.

In this embodiment, the index 311a consists of one or preferably two windows F1, F2 and the blank part 114a consists of two blank areas z1, z2 whose shape and position match those of the associated windows F1, F2 so that, when the nut 3a is rotated relative to the sleeve 1a, for the setpoint tightening position, the blank part 114a appears in the index 311a, while for other relative positions only the peripheral surface 111a appears in relation to the index 311a.

The sleeve 34a covers the peripheral surface 111a while the nut 3a is being screwed onto the thread 12a. Towards the end of the screwing, the visible peripheral surface 111a is completely covered and can only be seen through the windows F1, F2. The visible peripheral surface 111a gradually disappears when the nut 3a approaches the position associated with the setpoint tightening, because the two blank areas z1, z2 then coincide with the two windows F1, F2.

In principle, a single window F1 or F2 and a single blank area z1 or z2 would be sufficient. However, the accuracy of the setpoint tightening position depends on the width of the window and the width of the blank area. For exact adjustment with maximum precision, the two surface areas of the blank areas z1, z2 and the windows F1, F2 are identical. However, this requires a very precise maneuver at the end of the screwing, which is made all the more difficult by the need to apply the screwing force. It is therefore necessary to increase the surface area of the blank part 114a to allow adjustment, but this is at the expense of accuracy because the blank part 114a requires a certain angular rotation to cover the window (while at the same time overlapping).

The solution therefore consists in replacing this approach maneuver requiring a wide blank part 114a by two twinned windows F1, F2, of reduced width, and two blank areas z1, z2 with the same surface area and position as the two windows. This allows a much simpler and therefore quicker approach maneuver involving the appearance of the first blank area z1 in the first window F1 followed by its disappearance and then almost immediately its appearance in the second window F2; this also corresponds to the appearance of the first blank area z1 in the second window F2, confirming the precise adjustment.

The detection of the setpoint position is also facilitated by the double surface area which is the sum of the surface areas of the two blank areas z1, z2. The total disappearance of the visible peripheral surface 111a is also very important for checks if the visible surface is reflective at a certain wavelength. This allows all the couplings to be illuminated in a complex, low-light environment and makes it possible to immediately identify the incorrectly screwed or loose couplings which require intervention.

It should be noted that the adjustment of the index or the blank area may be such that the sleeve 34a leaves an uncovered strip at the end of the screwing, even if, at the same time, the blank area(s) z1, z2 coincide with the windows F1, F2.

The windows F1, F2 being elongated, oriented along the axis (xx), and as the peripheral surface 111a is perpendicular to the axis (xx), it follows that the illumination of this residual surface, visible in particular under ultraviolet light, reveals a cross-shaped image which, being very visible in a cluttered environment, constitutes a more visible reference than solely the visible mark of one window F1, or even of two windows F1, F2.

The direction of tightening is indicated by the arrow S (FIG. 5). During tightening, the windows move as follows:

The window F1 arrives first of all on the second area z2.

F2 still covers the support 111a which appears in the window F2. A very slight rotation then allows window F1 to be placed on the zone z1 and window F2 to be placed on the zone z2, confirming precise adjustment.

In conclusion, the invention relates to a coupling 100 for connecting two pipes C1, C2 comprising a first end piece 1 attached to a first pipe C1, a second end piece 2 attached to a second pipe C2, a clamping nut 3 carried by the second end piece 2 and tightening the latter against the first end piece 1, the first end piece 1 having on its free side a threaded segment 12 terminated by an end forming a sealing surface 13, the second end piece 2 having an end provided with a sealing collar 21 equipped with a lip 211 designed to be clamped against the sealing surface 13 of the first end piece 1, the nut 3 fitted freely rotating on the second end piece 2 overlapping its sealing collar 21 and screwing 31 onto the threaded segment 12 of the first end piece 1 to push against its collar 21 and clamp its sealing lip 211 against the sealing surface 13, coupling 100 being characterized in that the first end piece 1 has a nut crown 11 to hold the end piece 1 for screwing and an angular mark 111, the nut 3 has an index 311, and the run-out and the pitch of the thread of the threaded segment (12) of the first end piece 1 and the run-out and the pitch of the internal thread of the tapped segment 33 of the nut 3 are designed so that the positioning of the index 311 of the nut 3 with respect to the angular reference 111 of the first end piece 1 corresponds to tightening of the coupling 100 with the optimal elastic deformation of the sealing lip 211.

In this coupling, the nut crown 11 of the first end piece 1 is a faceted hexagonal crown, the head 31 of the nut 3 is a hexagonal head and the reference of the nut crown 11 of the first end piece 1 corresponds to a facet 112 of the crown 11 and the index 311 of the nut head 31 corresponds to an index 311 of the nut 3.

According to one characteristic, the hexagonal nut crown 11 has an angular reference 111 consisting of the numbers 1 to 6 and the nut head 31 has its facets equipped with an index 311 consisting of the numbers 1 to 6 associated respectively with each facet,
the exact tightening position being that in which the numbers on the nut head 31 match those on the nut crown 11,
a position in which the numbers of the index 311 are below the angular reference 111 corresponds to insufficient tightening and one in which the numbers of the index 311 exceed those of the angular reference 111 corresponds to excessive tightening.

Advantageously, the angular reference 111 of the nut crown 11 consists of an axial line associated with the numbers and the index 311 of the nut 31 is an axial line carried on the cylindrical surface extending the nut head by its threaded part screwed onto the threaded segment 12 of the first end piece 1.

### List of Main Elements

(without alphabetical suffixes, subject to exceptions)
100 Coupling
1 First end piece
11 Nut crown
111 Angular reference
111a Line
112 Facet
114 Blank area
115 Collar
12 Threaded segment
13 Sealing surface
2 Second end piece
21 Sealing collar
211 Sealing lip
212 Support crown
3 Clamping nut
31 Nut Head
311 Index
311a Line
312 Facet
32 Bearing surface
33 Internal thread
34 Sleeve
XX Axis of the coupling
C1 Pipe
C2 Pipe
F1, F2 Windows
z1, z2 Blank areas
S Tightening direction

1. Coupling (100, 200) with a setpoint tightening torque for connecting two pipes (C1, C2) comprising:
a first end piece (1) attached to a first pipe (C1),
a second end piece (2) attached to a second pipe (C2),
a clamping nut (3) that is borne by the second end piece (2) and clamps the latter against the first end piece (1),
the first end piece (1) having on its free side a threaded segment (12) terminating in an end forming a sealing surface (13),
the second end piece (2) having an end designed to be clamped against the sealing surface (13) of the first end piece (1),
the nut (3) fitted freely rotating on the second end piece (2), overlapping it and screwing (31) onto the threaded segment (12) of the first end piece (1) to push the end of the second end piece (2a) and clamp it against the sealing surface (13),
coupling (100) being characterized in that
the first end piece (1) has a nut crown (11) for holding the end piece (1) for the screwing thereof and an angular reference (111);
the nut (3) has an index (311), and
the run-out and the pitch of the thread of the threaded segment (12) of the first end piece (1) and the run-out and the pitch of the internal thread of the threaded segment (33) of the nut (3) are designed so that the positioning of the index (311) of the nut (3) with respect to the angular reference (111) of the first end piece (1) corresponds to the tightening of the coupling (100).

2. Coupling (100) according to claim 1,
characterized in that
the nut crown (11) of the first end piece (1) is a faceted hexagonal crown,
the head (31) of the nut (3) is a hexagonal head, and
the reference of the nut crown (11) of the first end piece (1) corresponds to a facet (112) of the crown (11) and the index (311) of the nut head (31) corresponds to an index (311) of the nut (3).

3. Coupling (100) according to claim 2,
characterized in that
the hexagonal nut crown (11) has an angular reference (111) consisting of the numbers 1 to 6 and the nut head (31) has its facets equipped with an index (311) consisting of the numbers 1 to 6 associated respectively with each facet,
the exact tightening position being that in which the numbers on the nut head (31) match those on the nut crown (11),
a position in which the numbers of the index (311) are below the angular reference (111) corresponding to insufficient tightening and one in which the numbers of the index (311) exceed those of the angular reference (111) corresponding to tightening with an excessive torque.

4. Coupling (100) according to any one of claims 1 to 3,
characterized in that
the angular reference (111) of the nut crown (11) consists of an axial line (111a) associated with the numbers and the index (311) of the nut (31) is an axial line (311a) carried on the cylindrical surface extending the nut head by its internal thread screwed onto the threaded segment (12) of the first end piece (1).

5. Coupling (200) according to claim 1,
characterized in that
the angular reference (111a) consists of a visible peripheral surface (111a) integrated in the first end piece (1a) between the end crown (11a) and the thread (12a) and a blank area (114a) chosen according to the rotation position of the nut (3a),
the index (311a) is at least one window (F1, F2) in the sleeve (34a) arriving on the blank area (z1, z2) at the end of the screwing to reveal it.

6. Coupling (200) according to claim 5,
characterized in that
the window (F1, F2) and the blank area (z1, z2) are duplicated in a matching way.

7. Coupling (200) according to claims 5 and 6,
characterized in that
the visible peripheral surface (111a) is a knurled surface covered with a color that is sensitive to UV light.
